(19) United States
(12) Patent Application Publication
(10) Pub. No.: US 2026/0010758 A1
(43) Pub. Date: Jan. 8, 2026

(54) SYSTEM AND METHOD FOR TUNING COMPOSITIONS OF HIGH-ENTROPY ELECTROCATALYSTS USING ACTIVE GENERATIVE GRAPH LEARNING

(71) Applicant: City University of Hong Kong, Hong Kong (HK)

(72) Inventors: Jun ZHANG, Hong Kong (HK); Shijun ZHAO, Hong Kong (HK)

(21) Appl. No.: 19/189,197

(22) Filed: Apr. 24, 2025

Related U.S. Application Data
(60) Provisional application No. 63/667,801, filed on Jul. 4, 2024.

(51) Int. Cl. G06N 3/042; C25B 11/089; G06N 3/045; G06N 3/0475; G06N 3/094

(52) U.S. Cl. CPC G06N 3/042; G06N 3/045; G06N 3/0475; G06N 3/094; C25B 11/089

(57) ABSTRACT

A system includes modules for DFT dataset generation, AGAT training, high-throughput prediction, CGAN generation, validation and augmentation, composition classification, and coordination. The DFT module generates and updates atomic data via spin-polarized DFT. The AGAT module trains attention-based models with translational, rotational, and permutational invariance. The prediction module estimates HER activity and ΔG(H) for new compositions. The CGAN module learns from predicted results and generates hypothetical compositions. The validation module runs DFT on selected candidates to update training data. The classification module uses KNN to group validated compositions and updates the formula list. The coordination module manages module interactions and iteration control.

### CROSS-REFERENCE TO RELEVANT APPLICATIONS

The present application claims priority from a U.S. provisional patent application Ser. No. 63/667,801 filed Jul. 4, 2024, and the disclosure of which are incorporated by reference in their entirety.

### TECHNICAL FIELD

The present invention relates to materials science and deep learning, and more specifically to systems and methods for optimizing high-entropy electrocatalyst compositions through active learning combined with deep generative graph models.

### BACKGROUND

The global energy crisis and climate change highlight the urgency for clean energy and efficient conversion technologies. The hydrogen evolution reaction (HER), essential for splitting water and storing energy chemically, requires highly active and environmentally friendly electrocatalysts. While noble metals like Pt and Pd offer excellent HER performance, their scarcity and cost drive the search for more affordable alternatives.

High-entropy alloys (HEAs), composed of five or more principal elements or characterized by high configurational entropy, are widely known for their mechanical strength and have recently emerged as promising electrocatalysts at the sub-nanometer scale. Techniques such as ultrafast cooling enable the synthesis of sub-2 nm HEA nanoparticles (NPs) with disordered atomic structures, even from immiscible elements. However, optimizing high-entropy electrocatalysts (HEECs) remains challenging due to the vast compositional space. Employing ab initio simulations for exploring this space are computationally demanding, often requiring thousands of calculations per composition. To reduce the computational burden, it is essential to prioritize low-performing compositions and narrow the search space.

Recently, data-driven methods have been increasingly employed to accelerate the discovery of catalysts, structural materials, and high-entropy electrocatalysts (HEECs). These approaches encompass global optimization, conventional machine learning, and deep learning techniques. Conventional models, such as linear regression and shallow neural networks, are data-efficient and rely heavily on well-crafted descriptors. However, their limited flexibility often hinders performance in complex, high-dimensional systems.

In contrast, deep learning models, such as graph neural networks (GNNs), offer end-to-end predictions and naturally preserve physical symmetries such as translation, rotation, and reflection. These points make them well-suited for representing atomic-scale interactions without the need for extensive feature engineering. Despite their advantages, deep-learning models typically require vast datasets (e.g., often amounting to millions of data frames) for a single HEEC system. Moreover, because the majority of compositions within the HEEC space exhibit unsatisfactory catalytic activity, exhaustive sampling remains highly inefficient. These limitations underscore the importance of learning strategies that prioritize high-value compositions rather than indiscriminate data generation. Furthermore, active learning (AL), which strategically selects the most informative data points to label, has demonstrated potential in reducing data demands while maintaining model accuracy. The AL approach has shown effectiveness in HEA development. Nevertheless, the AL approach scenarios in the field of HEEC remain limited.

Accordingly, there is a need for a targeted, data-efficient framework that integrates active learning with deep graph-based models to rapidly identify electrocatalyst compositions

### SUMMARY OF INVENTION

It is an objective of the present invention to provide systems and methods to address the aforementioned shortcomings and unmet needs in the state of the art.

In the present invention, an efficient active graph learning strategy is introduced, which autonomously requests training data during iterative active learning loops. The framework integrates atomic graph attention networks (AGAT), conditional generative adversarial networks (CGAN), and k-nearest neighbors (KNN) models into the active learning process. Prior studies have demonstrated that high-entropy electrocatalysts (HEECs) composed of Ni, Co, Fe, Pd, and Pt exhibit high oxygen reduction activity, making the proposed system a representative model for investigating the hydrogen evolution reaction (HER), a benchmark for electrocatalytic performance.

Furthermore, the evolution of datasets generated by the CGAN model is examined, revealing that the proposed framework achieves high HER activity with substantially smaller datasets while maintaining predictive accuracy. Five HEEC compositions with superior HER performance are identified through this process. Experimental validation confirms the catalytic activity of the recommended candidates. Owing to its modular design, the proposed approach can be readily extended to the prediction of other catalytic reactions on HEA systems in both computational and experimental settings.

In accordance with a first aspect of the present invention, a system for optimizing high-entropy electrocatalyst compositions through active learning combined with deep generative graph models is provided. The system includes a density functional theory (DFT) dataset generation module, an AGAT training module, a high-throughput prediction module, a CGAN generation module, a validation and augmentation module, a composition classification module, and a coordination module. The DFT dataset generation module is configured to generate and update a DFT database of atomic structures via spin-polarized DFT calculations. The AGAT training module is configured to receive a DFT dataset from the DFT database and train at least one A GAT model that integrates translation, rotation, and permutation invariance. The high-throughput prediction module is configured to apply the trained AGAT model to predict HER activity for newly appended compositions selected from a dynamically updated formula list, thereby generating predicted compositions and their associated hydrogen adsorption free energy values. The CGAN generation module is configured to receive the predicted compositions and the associated hydrogen adsorption free energy values from the high-throughput prediction module, to train multiple CGAN models conditioned on the predicted hydrogen adsorption free energy values, and to generate a plurality of hypothetical compositions using selected CGAN generator models. The validation and augmentation module is configured to perform high-throughput DFT simulations on a selected subset of the generated hypothetical compositions to produce updated labeled datasets. The composition classification module is configured to categorize the hypothetical compositions resulting from DFT validation performed by the validation and augmentation module using a KNN model, and to append classification results to the formula list for use in subsequent active learning iterations. The coordination module is configured to orchestrate interactions among DFT dataset generation module, A GAT training module, high-throughput prediction module, CGAN generation module, validation and augmentation module, and composition classification module and to control the number of the active learning iterations.

In accordance with a second aspect of the present invention, a method for optimizing high-entropy electrocatalyst compositions through active learning combined with deep generative graph models is provided. The method includes steps as follows: generating and updating, by a DFT dataset generation module, a DFT database of atomic structures via spin-polarized DFT calculations; receiving, by an AGAT training module, a DFT dataset from the DFT database; training, by the AGAT training module, at least one AGAT model that integrates translation, rotation, and permutation invariance; applying, by a high-throughput prediction module, the trained AGAT model to predict HER activity for newly appended compositions selected from a dynamically updated formula list, thereby generating predicted compositions and their associated hydrogen adsorption free energy values;
receiving, by a CGAN generation module, the predicted compositions and the associated hydrogen adsorption free energy values from the high-throughput prediction module; training, by the CGAN generation module, multiple CGAN models conditioned on the predicted hydrogen adsorption free energy values; generating, by the CGAN generation module, a plurality of hypothetical compositions using selected CGAN generator models; performing, by a validation and augmentation module, high-throughput DFT simulations on a selected subset of the generated hypothetical compositions to produce updated labeled datasets; categorizing, by a composition classification module, the hypothetical compositions resulting from DFT validation performed by the validation and augmentation module using a KNN model; appending, by the composition classification module, classification results to the formula list for use in subsequent active learning iterations; and controlling, by a coordination module, the number of the active learning iterations.

### BRIEF DESCRIPTION OF DRAWINGS

Embodiments of the invention are described in more details hereinafter with reference to the drawings, in which:

FIG. 1 is a block diagram illustrating a system for tuning compositions of high-entropy electrocatalysts using active generative graph learning according to some embodiments of the present invention;

FIG. 2 illustrates a method having an active learning loop for discovering high-performance HEECs according to some embodiments of the present invention;

FIG. 3 illustrates the data flow and internal retraining mechanism involved in the iterative training and update of AGAT models as part of the system's active learning cycle, according to some embodiments of the present invention;

FIG. 4A illustrates the overall architecture of the conditional adversarial training process according to some embodiments of the present invention;

FIG. 4B illustrates a schematic structure of the generator;

FIG. 4C illustrates a schematic structure of the discriminator;

FIG. 5A shows the distribution of all compositions calculated by DFT in all active loops;

FIG. 5B shows the dataset size compared to other work; and

FIGS. 6A, 6B, and 6C show AGAT performance on the test dataset at active learning loop number 15.

### DETAILED DESCRIPTION OF THE INVENTION

In the following description, system and method for tuning compositions of high-entropy electrocatalysts using active generative graph learning and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present invention, active learning (AL) is introduced as an effective strategy for narrowing the compositional search space in the discovery of high-entropy electrocatalysts (HEECs). In the present disclosure, achieving high predictive accuracy for low-performance candidates is unnecessary, while compositions with desirable hydrogen evolution reaction (HER) activity should be prioritized for accurate evaluation. By strategically allocating computational resources toward high-value regions of the design space and enabling automated candidate exploration, the AL framework significantly accelerates the electrocatalyst development process with minimal human intervention.

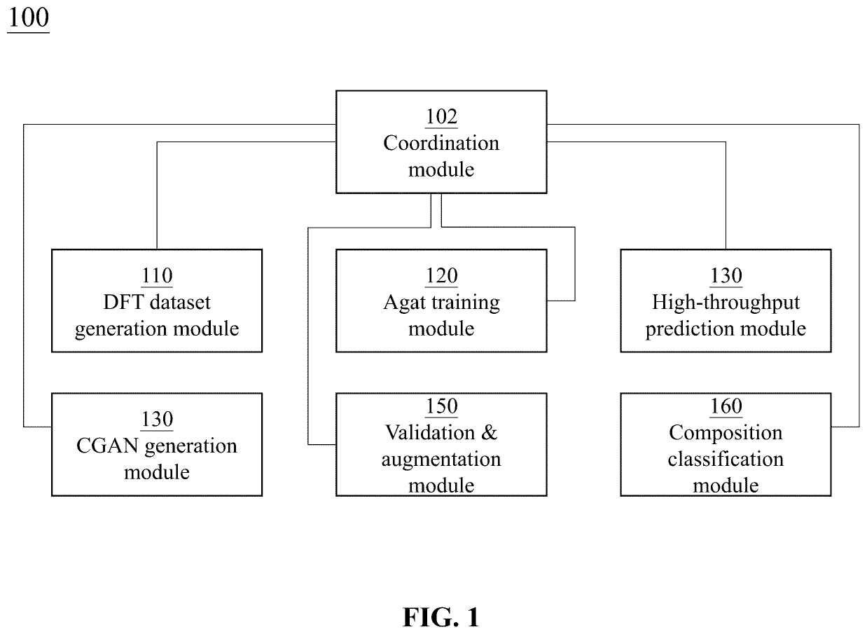

FIG. 1 is a block diagram illustrating a system 100 for tuning compositions of high-entropy electrocatalysts using active generative graph learning according to some embodiments of the present invention. The system 100 includes a coordination module 102, a density functional theory (DFT) dataset generation module 110, an atomic graph attention network (AGAT) training module 120, a high-throughput prediction module 130, a conditional generative adversarial network (CGAN) generation module 140, a validation and augmentation module 150, and a composition classification module 160.

The coordination module 102 is configured to orchestrate the interaction and data flow among all modules within the system 100. In one embodiment, the coordination module 102 maintains control over iteration timing, loop updates, and dataset synchronization. The coordination module 102 facilitates continuous refinement of model accuracy and search direction by initiating each iteration of the active learning loop with updated models and newly labeled compositions.

The DFT dataset generation module 110 is configured to generate atomic structural data using spin-polarized first-principles electronic structure calculations. The resulting data include total energy values, atomic forces, and structural descriptors derived from equal-molar compositions. In one embodiment, the generated dataset is updatable through execution of the AL loop.

The AGAT training module 120 receives the DFT dataset from the DFT dataset generation module 110 or an augmented version thereof (i.e., the updated components for the DFT dataset). The AGAT training module 120 is further configured to train an AGAT model based on the inputs from the DFT dataset. The AGAT model inherently incorporates translation, rotation, and permutation invariance, and is capable of capturing atomic interactions in high-entropy electrocatalyst systems.

The high-throughput prediction module 130 receives the trained AGAT model from the AGAT training module 120 and applies it to a selected subset of compositions retrieved from a dynamically updated formula list. The high-throughput prediction module 130 performs high-throughput predictions of target properties, focusing exclusively on newly appended compositions while omitting those from earlier iterations.

The CGAN generation module 140 receives the predicted compositions and corresponding ΔG(H) values (i.e., hydrogen adsorption free energy values) from the high-throughput prediction module 130. The CGAN generation module 140 is configured to train multiple conditional generative adversarial networks (CGANs), each comprising a generator and a discriminator. These CGANs are trained in parallel using the property-labeled data to learn composition distributions associated with improved catalytic activity. Upon completion of training, the CGAN generator component from each CGAN is evaluated. In some embodiments, only the top-performing CGAN generators are selected for downstream composition generation. The trained CGAN generators are then employed to produce hypothetical compositions directed toward regions of the composition space associated with low ΔG(H) values.

The validation and augmentation module 150 receives a selected subset of hypothetical compositions generated by the CGAN generation module 140. These hypothetical compositions are subjected to high-throughput DFT simulations by the validation and augmentation module 150 to compute accurate property values and structural data. The validated results are compiled into a new dataset by the validation and augmentation module 150, which is appended to the existing DFT database originally created by the DFT dataset generation module 110. The updated dataset is then transmitted to the A GAT training module 120 to support retraining in subsequent learning cycles.

The composition classification module 160 receives a selected subset of validated hypothetical compositions from the validation and augmentation module 150. The composition classification module 160 is configured to perform classification using a k-nearest neighbors (KNN) algorithm. In one embodiment, the validated hypothetical compositions are categorized into a predefined number of representative classes. These classifications are then appended to the formula list, which serves as a refreshed input to the high-throughput prediction module 130 for the next active learning iteration.

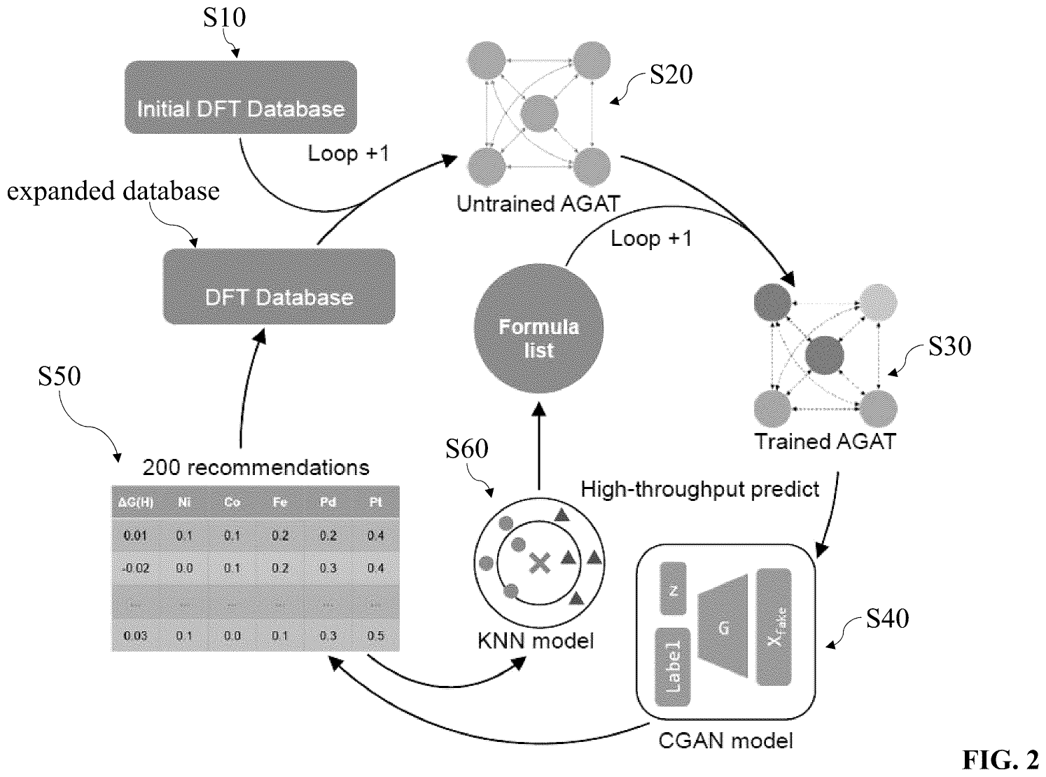

FIG. 2 illustrates a method having an active learning loop for discovering high-performance high-entropy electrocatalysts (HEECs) according to some embodiments of the present invention. The proposed method employs an AL framework integrating multiple machine learning models using the system 100 (e.g., an atomic graph attention network, a conditional generative adversarial network, and a k-nearest neighbors classifier) to efficiently search and optimize high-entropy electrocatalyst (HEEC) compositions for enhanced hydrogen evolution reaction (HER) activity. The method operates as an iterative learning loop and includes steps S10, S20, S30, S40, S50, and S60.

Step S10 is performed by the DFT dataset generation module 110 and involves the construction of an initial database derived from spin-polarized first-principles electronic structure simulations. Specifically, the process begins with calculations to generate a dataset of atomic structures. In some embodiments, the structures may be composed of equal molar compositions and are used to extract total energies, atomic forces, and other physical descriptors. The resulting data form an initial DFT database, which serves as the foundational training set for the AGAT training module 120.

Step S20 is performed by the AGAT training module 120. In this step, an untrained A GAT model is trained using the initial DFT dataset provided by the DFT dataset generation module 110. The AGAT model exhibits inherent interpretability and incorporates translation, rotation, and permutation invariance, enabling accurate representation of atomic interactions in HEECs. In some embodiments, upon completion of training, the trained AGAT model is transmitted to the high-throughput prediction module 130 for downstream inference.

Step S30 is performed by the high-throughput prediction module 130. In each iteration of the AL loop, 20 new compositions are appended to a formula list. The trained AGAT model is then employed by the high-throughput prediction module 130 to perform high-throughput property predictions exclusively for the most recent 40 compositions in the formula list. This step prioritizes the identification of high-potential candidates while disregarding outdated compositions generated in earlier AL iterations.

Step S40 is executed by the CGAN generation module 140. In this step, the predicted compositions and their associated ΔG(H) values are received from the high-throughput prediction module 130. The CGAN generation module 140 trains multiple conditional generative adversarial networks (CGANs), each comprising a generator and a discriminator. These CGANs are trained in parallel using the property-labeled data. Upon completion of training, the generator component from each CGAN is evaluated. In some embodiments, only the top-performing generators are selected and employed to produce 1000 hypothetical compositions directed toward regions of the composition space associated with low ΔG(H) values and potentially enhanced HER performance.

Step S50 is performed by the validation and augmentation module 150. A selected subset of the hypothetical compositions generated by the CGAN generation module 140 is subjected to high-throughput DFT simulations or DFT validation. These calculations yield accurate ΔG(H) values and structural descriptors. The validated results are compiled into a new dataset and appended into the existing DFT database originally created by the DFT dataset generation module 110 (i.e., by Step S10). The updated dataset is transmitted to the AGAT training module 120 for retraining, supporting the next iteration of the AL loop. The process enhances model accuracy while minimizing computational redundancy.

Step S60 is performed by the composition classification module 160. In one embodiment, a selected subset of the validated hypothetical compositions obtained from the validation and augmentation module 150 (i.e., the result from DFT validation performed by the validation and augmentation module 150) is categorized using a k-nearest neighbors (KNN) algorithm. The validated hypothetical compositions are grouped into 20 representative classes. The resulting class labels are appended to the formula list, which is further reused in the subsequent AL iteration.

By following the workflow described above, the AGAT and CGAN models of the AGAT training module 120 and the CGAN generation module 140 are both updated at the end of each AL iteration using the augmented dataset. The coordination module 102 orchestrates the entire process by managing loop transitions and data exchange. The subsequent iteration (Loop+1) begins with retrained models and a refreshed set of formula candidates. This closed-loop framework enables efficient and targeted exploration of the HEEC composition space while significantly reducing the number of required DFT calculations.

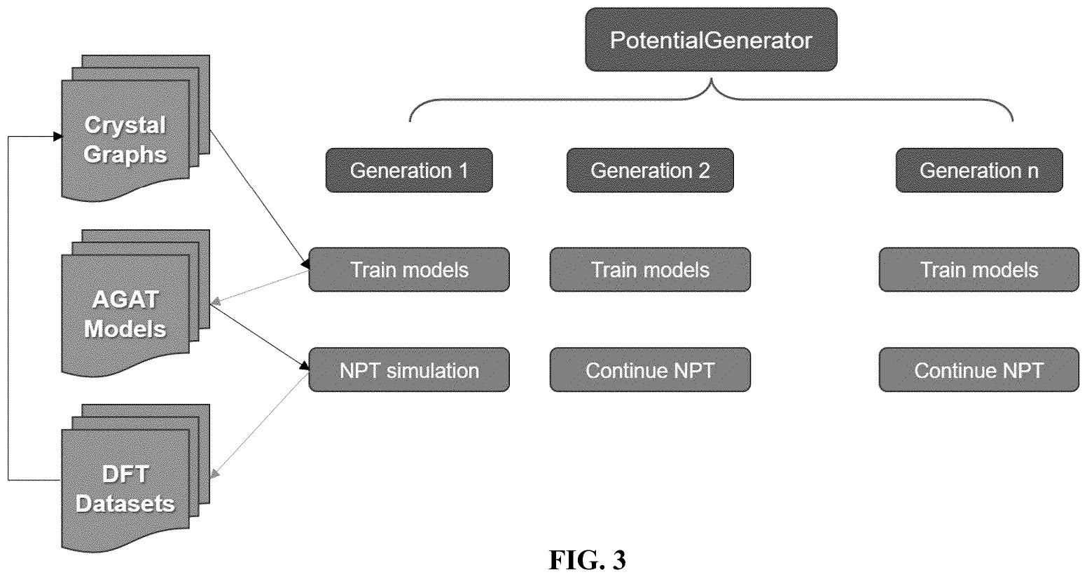

FIG. 3 illustrates the data flow and internal retraining mechanism involved in the iterative training and update of AGAT models as part of the system's active learning cycle, according to some embodiments of the present invention. This data flow and retraining process are implemented across the AGAT training module 120 and the validation and augmentation module 150. The coordination module 102 orchestrates the data exchange across these modules in each iteration. This subroutine operates in connection with Steps S20 and S50 described above, and provides a detailed view of how model refinement is performed dynamically and repetitively across multiple iterations of the active learning loop.

In each iteration of the active learning loop, three distinct repositories are employed and updated: (i) a crystal graph repository for storing graph representations derived from DFT-optimized structures; (ii) an AGAT model repository for tracking versions of trained models; and (iii) a DFT dataset repository for maintaining raw input and output simulation data.

The DFT datasets, originally generated in Step S10 and incrementally expanded in Step S50, are converted into crystal graph representations, which are stored and utilized as standardized inputs for AGAT model training. In each generation, all available crystal graphs in the repository are loaded collectively and used to train multiple AGAT models in parallel. Once trained, these AGAT models are deployed simultaneously to perform high-throughput atomistic simulations, including but not limited to NPT molecular dynamics, to assess predictive consistency.

These simulations are executed concurrently to accelerate evaluation. During or following inference, the system is further configured to assess the confidence levels of AGAT predictions. In one embodiment, if substantial variation or inconsistency is observed among the outputs of multiple AGAT models, such as discrepancies in predicted total energy or atomic forces, the corresponding structural data are flagged as uncertain. These flagged structures are automatically subjected to additional DFT calculations by the validation and augmentation module 150. Such confidence-based feedback mechanism selectively augments the training dataset with structurally or chemically ambiguous samples, thereby improving the robustness of the AGAT models in underrepresented or high-uncertainty regions of the HEEC compositional space.

Furthermore, in the present system, the CGAN model serves as a core mechanism within the CGAN generation module 140 to explore compositions with enhanced HER performance in the subsequent active learning loop. Unlike classical generative adversarial networks, the CGAN model of the CGAN generation module 140 incorporates predefined chemical constraints through conditioning inputs to guide the sample generation process.

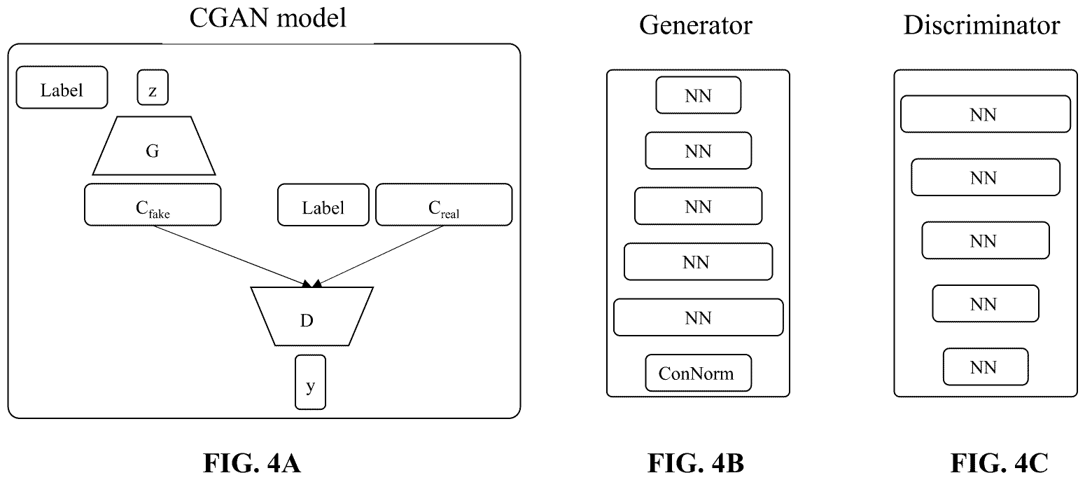

FIG. 4A illustrates the overall architecture of the conditional adversarial training process according to some embodiments of the present invention. FIG. 4B illustrates a schematic structure of the generator, and FIG. 4C illustrates a schematic structure of the discriminator.

The architecture of the CGAN model includes two principal components: a generator G and a discriminator D. The illustration details the generator network, which receives two inputs: a conditioning label and a random latent variable z. The conditioning label corresponds to a target Gibbs free energy of hydrogen adsorption, with the optimal value being ΔG=0 eV. These inputs are processed through a stack of densely connected neural networks (NNs), followed by a concentration normalization layer (ConNorm), which constrains the total concentration of elements in each generated composition C_{fake} to sum to 1.0. The randomness introduced by z allows the generator G to propose novel and diverse compositions that have not been previously sampled.

The discriminator D is also implemented as a multilayer neural network. The discriminator D receives both the generated compositions C_{fake} and real compositions Cᵣₑₐₗ from the training dataset, along with their corresponding conditioning labels. The discriminator D outputs a binary or probabilistic score y that reflects the likelihood that a given input composition is real. During training, the generator G is optimized to produce outputs that can “fool” the discriminator D, while the discriminator D is trained to distinguish between real and generated compositions. This adversarial process enables the generator G to approximate the distribution of high-performance compositions conditioned on desired HER activity.

Once training converges, the generator's parameters are fixed. The trained generator G is then deployed to sample new compositions that match target ΔG(H) conditions and are directed toward chemically relevant regions of the compositional space. These generated candidates are subsequently passed to the validation and augmentation module 150 for DFT evaluation in Step S50, forming a key feedback loop in the active learning cycle.

Moreover, in order to refine model performance within the region of interest identified by the CGAN generation module 140 in the previous iteration, the system 100 performs targeted augmentation of the DFT dataset. The compositions proposed by the trained generator can be selected as candidate factors for structural exploration. The operation of augmentation is implemented collaboratively by the validation and augmentation module 150 and the DFT dataset generation module 110, with orchestration handled by the coordination module 102.

In one embodiment, the automated dataset generation workflow begins with the construction of a bulk structure in which atoms are randomly arranged according to the target composition. The bulk structure is then subjected to geometry relaxation using spin-polarized DFT simulations within the DFT dataset generation module 110. Upon reaching the ground state, a clean surface is cleaved from the relaxed bulk along a predefined crystal orientation.

Next, the validation and augmentation module 150 automatically places an adsorbate species, such as a hydrogen atom, on the clean surface at representative adsorption sites. The resulting surface-adsorbate systems undergo static DFT calculations, followed by ab initio molecular dynamics simulations to further explore relevant configurational space. A teach stage, structural relaxation is applied to ensure that intermediate and final geometries converge to local or global minima. The resulting DFT-labeled data are appended to the repository maintained by the DFT dataset generation module 110, and subsequently made available to the AGAT training module 120 for retraining in the next learning iteration.

Through this automated and modular workflow, the system 100 dynamically generates composition-specific training data tailored to high-priority regions in the compositional space, enabling the A GAT training module 120 and high-throughput prediction module 130 to iteratively improve model generalization across structurally diverse and catalytically relevant systems.

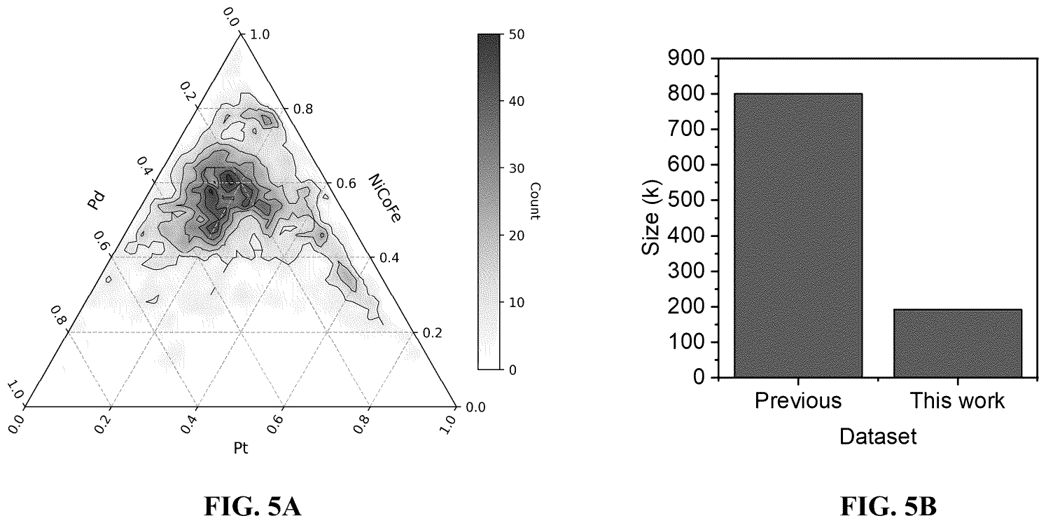

FIG. 5A shows the distribution of all compositions calculated by DFT in all active loops. FIG. 5B shows the dataset size compared to other work. A database constructed by active learning is provided.

As discussed above, only potentially high-performance HEECs are recommended in each AL loop. Herein, the appearance of concentrations is counted by the interval of 0.02. As shown in FIG. 5A, the compositional space of HEEC is only partially explored, and the required dataset size to screen high-performance HEECs is one-fourth compared to other previous work (see FIG. 5B), indicating the effectiveness of the AL approach in reducing training cost.

Moreover, the concentration of Pd and Pt with high attention ranges from 0.05 to 0.5, indicating that the price of HEECs can be significantly reduced with non-noble substitutions. In contrast, the range of Ni, Co, and Fe is narrower, ranging from 0.1 to 0.25. Additionally, the narrowness of Ni, Co, and Fe originates from the low discrimination of AL, aligning well with the physical nature that Ni, Co, and Fe elements show low activity for HER. That is, some concentrations away from the high-value compositions are also recommended by the CGAN model, featuring the exploration instinct of AL algorithms. In one embodiment, Ni—Co—Fe—Pd—Pt compositions with more than 0.3 at % of Ni—Co—Fe perform better than compositions dominated by Pd or Pt.

Accordingly, the evolution of CGAN predictions underlines again that there is no need to exploit the whole compositional space of HEECs, and the rational exploration made by ML in this work improves the efficiency of discovering high-performance HEECs for HER.

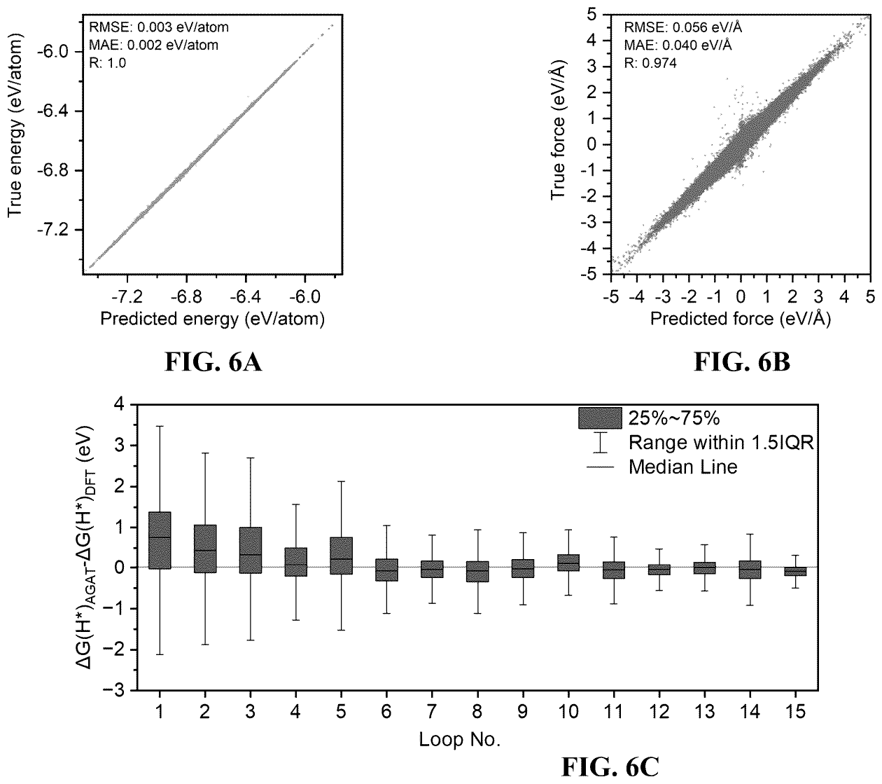

FIGS. 6A, 6B, and 6C show AGAT performance on the test dataset at active learning loop number 15, in which FIG. 6A shows the predicted total energy versus true total energy (in eV/atom); FIG. 6B shows the predicted atomic force versus true force (in eV/Å); and FIG. 6C shows the absolute difference between hydrogen adsorption free energies ΔG(H*) predicted by AGAT and by DFT. In FIG. 6C, the horizontal reference line denotes ΔG(H*)_{AGAT}=ΔG(H*)_{DFT}.

The discussion of performance of active learning is provided. The performance of the AGAT model is additionally evaluated on the test data. As shown in FIGS. 6A and 6B, the AGAT model of loop 15 accurately predicts total energies and atomic forces with mean absolute error of 0.002 eV/atom and 0.040 eV/Å, respectively, indicating the robustness of the well-trained interatomic potential model. The AGAT performance is also better than the state-of-the-art ML potential for high-entropy nanoclusters, showing the promise of the well-trained AGAT model.

In FIG. 6C, the model generalizability on predicting total energies and ΔG(H*) also improves with more AL loops. Initially, the predicted energies and ΔG(H*) deviate significantly from DFT results. Due to the error cancellation, the difference between AGAT- and DFT-predicted ΔG(H*) is smaller than bulk, clean surface, and adsorption structures. As the result of such deviations at initial five loops, the CGAN model is unstable in generating high-performance concentrations.

After that, the AL converges to 0.15 eV in predicting ΔG(H*). Additionally, no significant improvement on ΔG(H*) can be found after loop 12, and CGAN repeatedly generates candidates in the same region.

Based on the above results, it is found that the AL loops can be separated into two stages. At the first stage (loop 1-5), the AL is empowered by the generative model and starts to explore the compositional space of the Ni—Co—Fe—Pd—Pt system. Then, the AL discovers concentrations with good HER performance with high confidence at the second phase (after loop 5). Moreover, the AGAT accuracy is gradually improved as the CGAN recommends the same concentration distributions. Benefiting from these two phases, the AL can find high-performance HEECs with a smaller database.

In some embodiments, a loop threshold value may be defined via the coordination module 102. Once the number of active learning loops reaches the predefined threshold, the coordination module 102 is configured to output a composition recommendation report. The threshold value may range from 5 to 15 loops/iterations, such as 6, 7, 10, or 15 loops/iterations, depending on implementation requirements.

Specifically, after each loop, a new dataset is augmented and subsequently evaluated using the most recently trained AGAT model. For example, upon reaching the predefined number of loops, the composition recommendation report generated by the coordination module 102 may include entries similar to those shown in Table 1.

Table 1 presents representative compositions recommended in loop 6 and loop 7. The results indicate that high-entropy electrocatalysts (HEECs) exhibiting superior hydrogen evolution reaction (HER) activity commonly possess elevated concentrations of Pd and Pt. This observation suggests that, within the Ni—Co—Fe—Pd—Pt compositional system, Pd and Pt serve as the primary active sites for HER catalysis.

TABLE 1
Selected recommendations from loop 6 and loop
7. The numbers in chemical formula indicates
the number of atoms in the simulation cell.

| Formula | ΔG_{H} |
|---|---|
| Ni₈Co₇Fe₁₁Pd₁₆Pt₅₄ | 0.01 |
| Ni₉Co₁₂Fe₁₅Pd₁₃Pt₄₇ | 0.01 |
| Ni₆Co₆Fe₁₁Pd₇Pt₆₆ | −0.02 |
| Ni₁₀Co₁₄Fe₁₂Pd₃₂Pt₂₈ | 0.06 |
| Ni₇Co₉Fe₁₀Pd₄₉Pt₂₁ | 0.08 |

In summary, the present disclosure provides an active learning framework that enables efficient training of interatomic potential models while substantially reducing the required volume of DFT-calculated data. Through iterative sampling and model refinement, the system identifies non-equiatomic high-entropy electrocatalyst (HEEC) compositions exhibiting enhanced hydrogen evolution reaction (HER) activity after a limited number of learning cycles (e.g., seven generations, 6th or 7th loop). The results further indicate that Pd and Pt function as the principal active centers within the Ni—Co—Fe—Pd—Pt compositional space, and that increasing their concentrations leads to improved catalytic performance, which in some embodiments exceeds that of pure Pt or Pd metals.

According to some embodiments of the present invention, a number of novel features are introduced to enable the efficient training and deployment of deep graph-based interatomic potentials. The disclosed system allows for the training of deep-graph neural network potentials using a significantly reduced dataset, while seamlessly integrating AGAT, CGAN, KNN, and DFT codes. Within this integrated framework, material compositions are dynamically optimized during the active learning process, and DFT calculations are automatically executed for candidate compositions exhibiting exceptional properties. The resulting DFT dataset is enriched with high-performance compositions and can be used to train highly accurate interatomic potentials, which are refined further during subsequent simulations. In particular, the system supports optimization of elemental concentrations in high-entropy materials characterized by vast compositional spaces, and can be extended to optimize physical, chemical, or mechanical properties of such materials with minimal human input once the system is initialized.

Based on these features, the present invention achieves several advantages. The system automates the entire workflow, including data collection, crystal graph construction, ML model generation via a single configuration file, high-throughput DFT calculations, and atomistic simulations powered by the AGAT potential. New/novel compositions with specified property targets are recommended through the CGAN model and further classified by the unsupervised KNN model. The architecture also supports GPU-accelerated graph construction, static and dynamic simulations, and AGAT hyperparameter optimization using Bayesian techniques. AGAT potentials are trained on the fly and validated against both CGAN-generated compositions and DFT-calculated results, enabling iterative improvements in material design. In addition to optimizing compositions and concentrations in high-entropy systems, the system also facilitates fine-tuning of adsorbate-surface binding strength and particle diffusivity within target materials.

These capabilities allow the solution provided by present invention to be applied across a broad range of practical scenarios, including the development of materials for use under demanding conditions, the discovery of novel pharmaceutical compounds, protein structure prediction, and performance enhancement of existing materials. Compared to prior art, the invention offers substantial advantages, including fully automated A GAT training, the ability to train with smaller datasets, on-the-fly retraining during atomistic simulations, and reduced dependency on manual intervention during the optimization of material compositions.

The functional units and modules of the apparatuses and methods in accordance with the embodiments disclosed herein may be implemented using computing devices, computer processors, or electronic circuitries including but not limited to application specific integrated circuits (A SIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROM s, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. M any modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for optimizing high-entropy electrocatalyst compositions through active learning combined with deep generative graph models, comprising:
a density functional theory (DFT) dataset generation module configured to generate and update a DFT database of atomic structures via spin-polarized DFT calculations;
an atomic graph attention network (AGAT) training module configured to receive a DFT dataset from the DFT database and train at least one AGAT model that integrates translation, rotation, and permutation invariance;
a high-throughput prediction module configured to apply the trained AGAT model to predict hydrogen evolution reaction (HER) activity for newly appended compositions selected from a dynamically updated formula list, thereby generating predicted compositions and their associated hydrogen adsorption free energy values;
a conditional generative adversarial network (CGAN) generation module configured to receive the predicted compositions and the associated hydrogen adsorption free energy values from the high-throughput prediction module, to train multiple CGAN models conditioned on the predicted hydrogen adsorption free energy values, and to generate a plurality of hypothetical compositions using selected CGAN generator models;
a validation and augmentation module configured to perform high-throughput DFT simulations on a selected subset of the generated hypothetical compositions to produce updated labeled datasets;
a composition classification module configured to categorize the hypothetical compositions resulting from DFT validation performed by the validation and augmentation module using a k-nearest neighbors (KNN) model, and to append classification results to the formula list for use in subsequent active learning iterations; and
a coordination module configured to orchestrate interactions among DFT dataset generation module, AGAT training module, high-throughput prediction module, CGAN generation module, validation and augmentation module, and composition classification module and to control the number of the active learning iterations.

2. The system of claim 1, wherein the coordination module is further configured to define a loop threshold value and to generate a composition recommendation report once the number of the active learning iterations reaches the loop threshold value.

3. The system of claim 1, wherein the validation and augmentation module is further configured to append the updated labeled dataset to the DFT database and transmit an augmented dataset to the AGAT training module for retraining in subsequent learning iterations.

4. The system of claim 1, wherein the CGAN generation module comprises a generator configured to receive a target Gibbs free energy of hydrogen adsorption as a conditioning label and to output compositions whose elemental concentrations sum to 1.0 after normalization.

5. The system of claim 1, wherein the DFT dataset generation module, the AGAT training module, and the validation and augmentation module are configured to collaborate in converting DFT-optimized structures into crystal graph representations stored in a crystal graph repository.

6. The system of claim 1, wherein the AGAT training module is configured to train multiple AGAT models simultaneously using crystal graph representations stored in a crystal graph repository, and wherein the trained AGAT models are concurrently deployed for predictive simulations.

7. The system of claim 1, wherein the system is configured to assess the confidence levels of predictions made by the AGAT models, and to automatically subject structures exhibiting significant disparities among model predictions to additional DFT calculations.

8. The system of claim 1, wherein the high-throughput prediction module selects the 20 most recently added compositions in the formula list for property prediction in each iteration.

9. The system of claim 8, wherein the high-throughput prediction module is further configured to employ the trained AGAT model to perform high-throughput property predictions exclusively for the most recent 40 compositions in the formula list.

10. The system of claim 1, wherein the classification results generated by the composition classification module are appended to the formula list and used by the high-throughput prediction module in the next active learning iteration to enable compositional diversity in candidate selection.

11. A method for optimizing high-entropy electrocatalyst compositions through active learning combined with deep generative graph models, comprising:
generating and updating, by a density functional theory (DFT) dataset generation module, a DFT database of atomic structures via spin-polarized DFT calculations;
receiving, by an atomic graph attention network (AGAT) training module, a DFT dataset from the DFT database;
training, by the AGAT training module, at least one AGAT model that integrates translation, rotation, and permutation invariance;
applying, by a high-throughput prediction module, the trained A GAT model to predict hydrogen evolution reaction (HER) activity for newly appended compositions selected from a dynamically updated formula list, thereby generating predicted compositions and their associated hydrogen adsorption free energy values;
receiving, by a conditional generative adversarial network (CGAN) generation module, the predicted compositions and the associated hydrogen adsorption free energy values from the high-throughput prediction module;
training, by the CGAN generation module, multiple CGAN models conditioned on the predicted hydrogen adsorption free energy values;
generating, by the CGAN generation module, a plurality of hypothetical compositions using selected CGAN generator models;
performing, by a validation and augmentation module, high-throughput DFT simulations on a selected subset of the generated hypothetical compositions to produce updated labeled datasets;
categorizing, by a composition classification module, the hypothetical compositions resulting from DFT validation performed by the validation and augmentation module using a k-nearest neighbors (KNN) model;
appending, by the composition classification module, classification results to the formula list for use in subsequent active learning iterations; and
controlling, by a coordination module, the number of the active learning iterations.

12. The method of claim 11, further comprising:
defining, by the coordination module, e a loop threshold value; and
generating, by the coordination module, a composition recommendation report once the number of the active learning iterations reaches the loop threshold value.

13. The method of claim 11, further comprising:
appending, by the validation and augmentation module, the updated labeled dataset to the DFT database; and
transmitting, by the validation and augmentation module, an augmented dataset to the A GAT training module for retraining in subsequent learning iterations.

14. The method of claim 11, further comprising:
receiving, by a generator of the CGAN generation module, a target Gibbs free energy of hydrogen adsorption as a conditioning label; and
outputting, by the generator, compositions whose elemental concentrations sum to 1.0 after normalization.

15. The method of claim 11, further comprising:
converting, by the DFT dataset generation module, the AGAT training module, and the validation and augmentation module, DFT-optimized structures into crystal graph representations stored in a crystal graph repository.

16. The method of claim 11, further comprising:
training, by the AGAT training module, multiple AGAT models simultaneously using crystal graph representations stored in a crystal graph repository, wherein the trained AGAT models are concurrently deployed for predictive simulations.

17. The method of claim 11, further comprising:
assessing the confidence levels of predictions made by the AGAT models; and
automatically subjecting structures exhibiting significant disparities among model predictions to additional DFT calculations.

18. The method of claim 11, wherein the high-throughput prediction module selects the 20 most recently added compositions in the formula list for property prediction in each iteration.

19. The method of claim 18, wherein the high-throughput prediction module employs the trained AGAT model to perform high-throughput property predictions exclusively for the most recent 40 compositions in the formula list.

20. The method of claim 11, wherein the classification results generated by the composition classification module are appended to the formula list and used by the high-throughput prediction module in the next active learning iteration to enable compositional diversity in candidate selection.
